(19) United States
(12) Patent Application Publication
(10) Pub. No.: US 2014/0351165 A1
(43) Pub. Date: Nov. 27, 2014

(54) PROPERTY DEVELOPMENT HEDGE STRUCTURE

(71) Applicant: Frank Kimball, Evanston, IL (US)

(72) Inventor: Frank Kimball, Evanston, IL (US)

(21) Appl. No.: 13/899,875

(22) Filed: May 22, 2013

(51) Int. Cl. G06Q 40/06; G06Q 50/16

(52) U.S. Cl. CPC G06Q 40/06; G06Q 50/16
USPC 705/36 R

(57) ABSTRACT

A method for modeling a hedge structure that dynamically transfers financial and operating leveraged market risk between a real estate company and an investor as the real estate company's development projects go through the different risk phases of the development cycle resulting in market risk exposure changes.

### FIELD OF THE INVENTION

The present invention relates to a system and method for quantifying and transferring real estate market risk adjusted for specific levels of both financial and operating leverage between a real estate development company and one or more investors throughout an entire development cycle. Indirect investment structures are used. This method provides a way dynamically to hedge the company's market risk, unlike other methods which provide only static hedging.

### BACKGROUND OF THE INVENTION

Real estate has been a huge market in which the only way to gain exposure was to buy physical assets, either directly or indirectly through a fund, a Real Estate Investment Trust (REIT) or a real estate company. Direct investments require a lot of due diligence, extensive management experience, and expensive taxes and transaction costs. Having a diversified portfolio, which is out of reach for most small investors, is difficult to achieve. Recent studies show that investment strategies aiming at significant reduction in the diversifiable portfolio risk component require diversification across far more properties than are represented in typical institutional portfolios (Graff and Young, 1996). And, provided it can be achieved, it is difficult to shift exposures from one sector of the market to another or to generally reduce exposure. Indirect investments, on the other hand, are typically traded much more conveniently than direct investments. Besides the eased trading and handling, their main advantage compared to direct investments is the diversification of specific risk to multiple properties. However, since they only aim to facilitate the transaction they only consist of existing readily-made real estate investments and thus are not flexible and cannot meet certain hedging and investment needs. Market participants have long tried to structure new instruments that enable investors, at least in part, to overcome these shortcomings (Syz, 2008).

Several property derivative structures that have been developed and traded to this date being most of them structured as over-the-counter contracts (Syz, 2008). Property derivatives are financial instruments that are valued in relation to an underlying property index. These property instruments create new means of risk transfer between a broad range of investors, either looking for down market protection or to gain efficient and quick exposure to the upside potential of an underlying market. The number of structures increases as market participants try to design derivatives that replicate the familiar characteristics of direct property investment. At the individual homeowner's level there are several property related contracts that have been designed to reduce risk due to price fluctuations in the home such as reverse mortgages (lifetime annuity from the value of a home), sale-of-remainder contracts (sale of share in the house to another party with a contract to remain living in the house), shared appreciation mortgages, housing limited partnerships, home equity insurance in the form of index-linked mortgages (Shiller and Weiss, 1994) and index-linked property savings plans (Syz, 2008).

Previous examples refer to stabilized properties, that behave in very different ways from property development if we consider the market risk exposure it provides to the investor. An investment in a project that is being developed is exposed to different risk phases where investing in existing, fully operational properties provides a single risk regime (Geltner, Clayton, Miler and Eichholtz, 2001). Thus, there is an extremely important difference that is due to the fact that development investments have Operating Leverage (even if no Financial Leverage is employed) where investments in stabilized property do not. In the stabilized property investment, all the cost of obtaining a property occurs at the beginning and is perfectly correlated with the subsequent realization of the value of the property. However, in the development investment the costs are spread out in time, instead of occurring all at once up front, and are not perfectly correlated with the values of the future gross benefits to be obtained from the investment. In the stabilized investment there is only a one time variable purchase cost where in the development investment there are also future fixed construction costs. The greater those fixed costs compared to the value of the property being obtained and the later they occur in time relative to the obtaining of the property, the higher in general the Operating Leverage is. It is because of this Operating Leverage that the development investment involves very different levels of investment risk until the property is fully operational. The result is a very different economic opportunity cost of capital (OCC) in each different phase. For illustrative purposes we can simplify all the investment possibilities depending on the risk phase at which a property is acquired on three basic strategies. First, Core Strategy. This is a moderate risk/moderate return strategy, investing in core stabilized running properties that may require some form of enhancement or maintenance periodically. Second, Value-Added. This is a medium-to-high risk/medium-to-high return strategy that involves buying a property, improving it in some way, and selling it at an opportune time for a gain. Properties are considered value added when they exhibit management or operational problems, require physical improvement, and/or suffer from capital constraints. Third, Opportunistic. This is a high risk/high return strategy. The properties will require a high degree of enhancement. This strategy may involve investments in development, raw land, and niche property sectors. Investments are tactical and their aim is to take advantage of lower property prices to acquire assets at significant discounts. As it was explained, the terms core, value-added and opportunistic are only used as a basic guide since the number of strategies due to possible risk phases is mathematically infinite and there are not defined ratios differentiating each one of the general three. The most difficult aspect of these various risk phases is that since they each provide a different OCC, it is generally required to have a predesigned strategy in order to set up a viable capital structure (Brueggeman, William and Fisher, 1954). The development of dynamic versus static models has already been done to assess the fundamentals in land prices and urban growth (Capozza and Helsley, 1989) as well as the equilibrium forces on real estate markets (Williams, 1993). It is equally important to develop models that can address the dynamics in change of risk exposure in any given development of a property.

### PRIOR ART TO THE INVENTION

Patents have been granted to systems and methods for hedging and transferring real estate market risk in a simpler and more efficient way that traditional structures. However, all these systems, like the derivatives previously mentioned, apply almost exclusively to the investment risk associated with the long-term stabilized phase, and even if they include a valuation method for properties under development, they do so by adding the market value of each of the independent elements that constitute the property, failing to take into account the dynamic nature of the risk. Many of those systems use hedonic models, which are common in real estate appraisal, to break down the item being researched into its constituent characteristics, and obtain estimates of the contributory value of each characteristic (see U.S. Pat. No. 7,979,684: Fund for hedging real estate ownership risk using financial portfolio theory and data feed for analyzing the financial performance of a portfolio that includes real estate; and U.S. Pat. No. 7,822,668: Tool for hedging real estate ownership risk using financial portfolio theory and hedonic modeling). Other methods combine real estate assets in a fund that resembles an specific sector to be sold as shares which are valued using Net Operating Income (NOI) and Net Asset Value (NAV) related valuations (see Patent Application 20050015326: Methods and systems for facilitating investment in real estate). There are also methods that establish pairs of proxy assets that offset each other referenced to a real estate index to facilitate the transaction among pairs of investors who wish opposite positions (see U.S. Pat. No. 5,987,435: Proxy asset data processor). Further examples include methods for protecting a mortgage loan borrower in the event of a house market downturn, transferring that risk to an investor that receives a premium (see U.S. Pat. No. 8,190,516: Equity protection) or methods for financing the loan borrower by transferring to the lender a portion of the capital appreciation of the real estate asset (see U.S. Pat. No. 8,219,471: Real estate appreciation contract). All these methods that try to facilitate the transfer of a real estate investment position fail to address the dynamic nature of the risk a real estate company takes as it develops a property, and therefore cannot be used to transfer risk throughout the entire development cycle. This risk exposure varies even if the joint value of the elements that constitute the property does not or the index it is referenced to stays flat.

When applied to quantifying the overall market exposure of a real estate portfolio, most of the previous models recur to Net Asset Value (NAV) related methods. But NAV is a static, even backward-looking perspective that does not fully take into account the value-creating power that the property development provides. By valuing the property in a static way, all consequent quantification of expected return and risk is also static and fails to take into consideration the changing nature of the risk in a property being developed, which affects expected returns in a way that the mere addition of the sub-elements that constitute the property cannot assess. There is currently no available vehicle, system or method for hedging and transferring the investment risk associated to a company which holds a portfolio of real estate properties in which each one of them is at a different phase of the development process, and more important, in which the company's overall investment risk will vary as the properties become fully developed and enter the stabilized phase, and/or new projects are undertaken. All previously mentioned methods and vehicles provide a static hedging method, and not dynamic in the sense that it automatically rebalances itself to adjust for the change in market risk a real estate company has as its properties go through each stage in the development cycle. Existing indirect investment vehicles provide a means for an investor to achieve a diversified portfolio in stabilized property. But the difficulty of achieving diversification in development property is even higher. Developing a property can be essentially analyzed as a real option but it is very difficult to collect information across different real estate markets to assess the optimal development conditions in each segmented market (Williams, 1991).

### SUMMARY OF THE INVENTION

The present invention constitutes a method for modeling a Hedge Structure that enables the transfer of financial and operating leveraged market risk between a real estate company and an investor (or two companies). This Hedge Structure can replicate the specific leveraged market risk (leveraged Beta or systematic risk) any real estate company is exposed to excluding its specific projects' risk (unsystematic risk).

The invention further establishes a method for quantifying the dynamic market risk exposure that a real estate development company will have as the different properties in its portfolio go through the different phases of the development process. This market risk exposure will vary even if the company does not purchase or dispose of any property, due to the different level of risk in relation to the overall market that a property has as it goes through the different development phases. Once the specific risk at any time is calculated, it can be inputted into the Hedge Structure so that it effectively tracks the company's risk by replicating through its internal payment structure the economic principles that define each specific risk strategy any company is pursuing.

The invention includes a system for the rebalancing of the Hedge Structure based on the company's internal use of resources so that the risk being transferred to the investor from the company varies as the company's projects go through their different phases in the development cycle, from raw land to fully operational property and back as the company starts new projects.

A computer-implemented system is also developed by which the investor can choose through an interface from different markets, sectors, and companies constructing different portfolios. The computer-based system calculates the overall return/risk characteristics of the portfolio so that the investors can better make an investment decision.

The computer implemented system also allows the investor to rebalance his portfolio by restructuring his allocation to different markets, sectors and companies as the overall risk exposure changes.

Advantageously, the invention provides a way for the investors to obtain the desired leverage adjusted market exposure while avoiding the problems of direct investment in real estate. Its specific structure also allows the investor to use modern portfolio analysis to assess the return/risk characteristics of his investment considering not only the investment in isolation but in relation to other investments in the overall portfolio following Modern Portfolio Theory (Markowitz, 1990). The advantages of including real estate in an investment portfolio have been thoroughly studied (Andersson and Svanberg, 2003).

An additional advantage of the invention is that it is also a cost effective way for the real estate company to transfer part of his market exposure without having to actually sell his properties and in a far more efficient way. If a real estate company decided to use any of the previously described real estate derivatives to hedge its portfolio, it would only get a static, one-time hedge, whereas by using the present invention would provide a dynamic hedge that will automatically rebalance as the company changes its market risk.

A further advantage of the invention from the real estate company's perspective is that in exchange to transferring part of its market risk it can raise additional capital to be used to pursue new projects at better conditions than alternative financing methods. Debt financing often require the immediate payment of interest regardless of the projects' status. This can become a liquidity burden for a development firm undertaking the construction of a new property even if the amortization of the principal can be deferred. Moreover, even if the company is careful to maintain prudent liquidity ratios, cash reserves would not be efficiently used and this may easily diminish future rates of returns. The situation is even more difficult in the case of a downward market where high interests could magnify negative returns and potentially push equity into negative numbers. Equity participating Debt involves the use of warrants or convertible instruments which effectively defer the compensation until properties are developed. However, they have the adverse effect of diluting the development firm's equity which could potentially lead to tensions between different equity class holders. The combination of financing with the dynamic transfer of leveraged market risk can be very efficient in any given real estate company's capital structure.

The advantages of the inventions may be more clearly understood and appreciated from a review of the following detailed description and by reference to the appended drawings and claims.

### BRIEF DESCRIPTION OF THE DRAWINGS

FIG. 1 is a diagram illustrating the different phases in a development project with decremented level of risk as well as the relation between each level of risk as it relates to the modeling of the Hedge Structure.

FIG. 2 is a diagram illustrating the method for calculating the Subordination Ratio and its corresponding Elasticity Delta to market due to Financial Leverage.

FIG. 3 is a diagram illustrating the method for calculating the Retention Ratio and its corresponding Elasticity Delta to market due to Operating Leverage.

FIG. 4 is a diagram illustrating the combined effect of Financial and Operating Leverage as well as three diagrams showing how the yield and growth components vary as the Retention Ratio Varies.

FIG. 5 is a diagram illustrating the method for Modeling the Hedge Structure.

FIG. 6 is a diagram illustrating the method for Monitoring and Correcting the Hedge Structure. The method allows one to assess the sustainability of the Hedge Structure by analyzing the internal use of resources of the company.

FIG. 7 is a diagram illustrating the method for Modeling a Simplified Hedge Structure to be used for lending purposes.

FIG. 8 illustrates an example of Floor & Cap on the Hedge Structure.

FIG. 9 illustrates the method for constructing tranches from single a Hedge Structure.

FIG. 10 is a diagram illustrating the method for Modeling a Simplified Hedge Structure to be used in swaps for hedging purposes.

FIG. 11 is an example of the calculation performed by a computer base system to provide a distribution of returns based on the Retention Ration.

FIG. 12 illustrates the method for calculating the company's Alpha components or error terms with regression analysis and the graphics monitoring it.

FIG. 13 is a diagram illustrating the computer-based method for the Construction of a Portfolio comprised of one or more Hedge Structures.

FIG. 14 is a diagram illustrating the computer-based elements for Monitoring the Portfolio.

FIG. 15 is a diagram illustrating the method for Rebalancing the Portfolio.

### DETAILED DESCRIPTION OF THE INVENTION

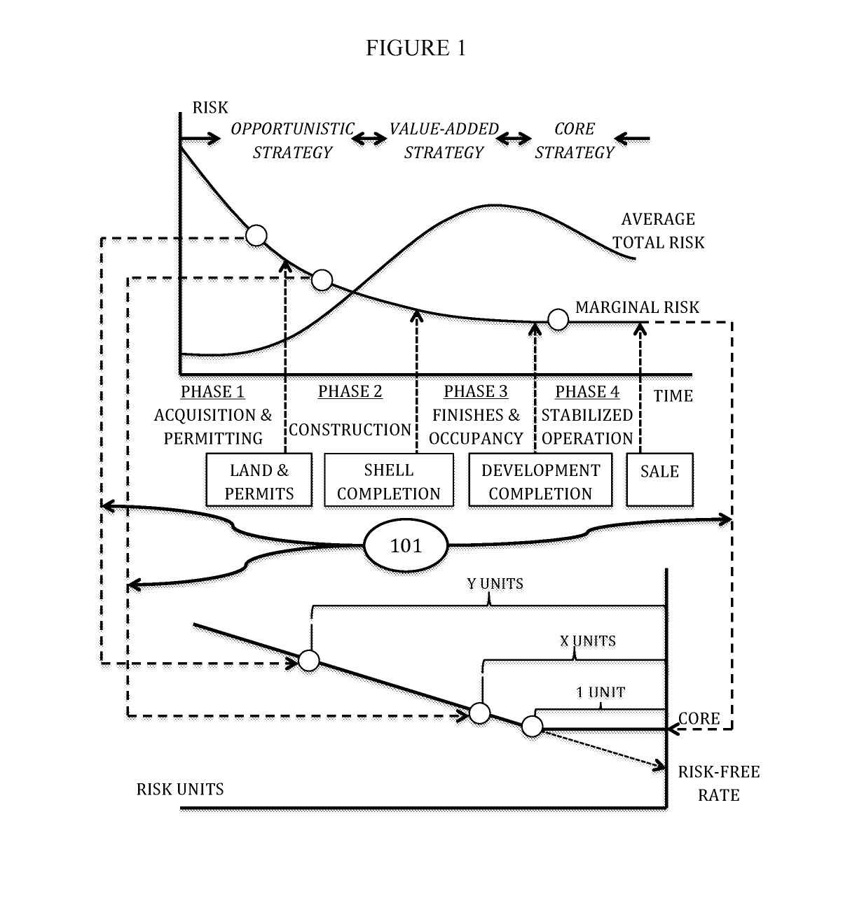

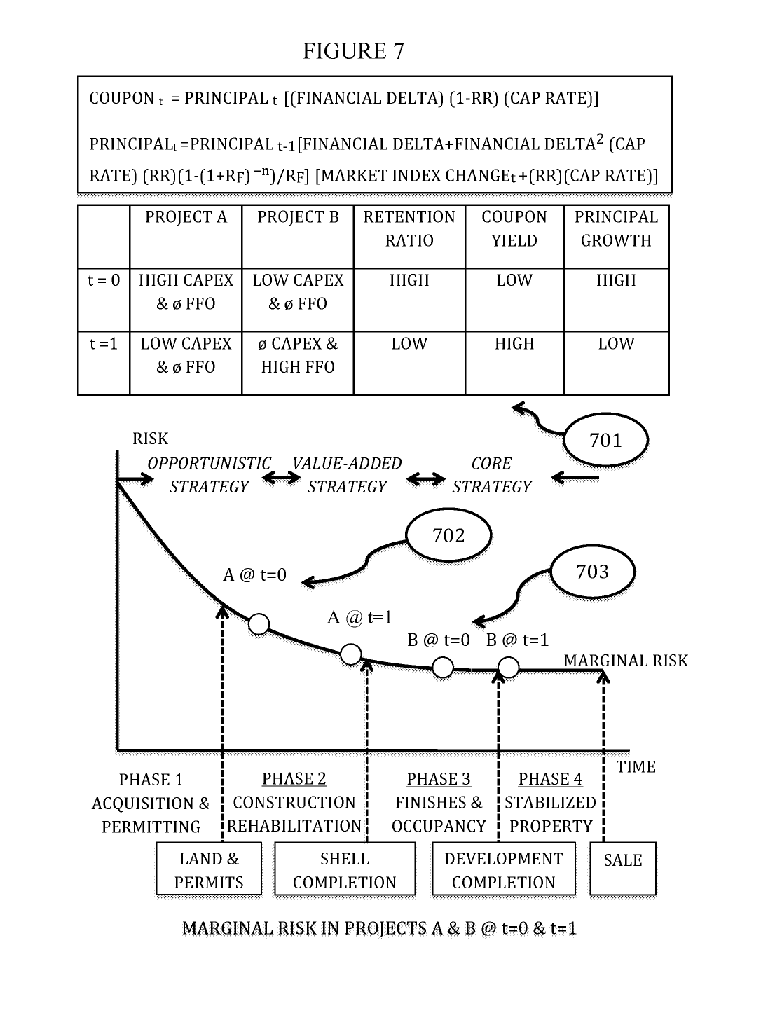

Points in paragraphs 031-36 herein (and drawing FIGS. 1-6) refer to the Hedge Structure's Mechanics, Points in paragraphs 037-40 (and drawing FIGS. 7-10) refer to the Hedge Structure's Applications, and Points in paragraphs 041-44 (and drawings 11-14) refer to the Hedge Structure's Analysis and Monitoring.

Hedge Structure's Mechanics: Economic Principles (See FIG. 1).

The following points will describe how the model enables the design of a payment structure (hereafter known as the Hedge Structure) such that the payoffs replicate the exact economic effects that would occur if a real estate company theoretically transferred its financial and operating leveraged market exposure to an investor or another company throughout an entire or part of a development cycle. Market risk (also known as systematic risk) is the risk inherent to the entire market and which cannot be mitigated through diversification but only by being hedged. Leverage adjusted market risk is the market risk adjusted for the specific amount of both operating and financial leverage used by a company. FIG. 1 illustrates the different phases in a development cycle with decremental levels of risk and the relationship between them which is based on the principle that the expected return risk premium must be the same per unit of risk across different types of investments. In real estate, any development strategy is a derivative of the underlying stabilized property market in which this strategy is being developed and must therefore provide the same return per unit of risk. The system that will be explained hereafter models the Hedge Structure [process 101] by calculating the elasticity or sensitivity of each development phase to the market. This elasticity is defined as a multiple of the basic risk unit that would hold a stabilized property in that specific market. The Hedge Structure has two components that mimic the returns in real estate, namely yield and capital growth. The higher the yield and lower the growth, the more the Hedge resembles a Core Strategy. The lower the yield and higher the growth the more the Hedge resembles an Opportunistic Strategy. It is the relative weights of both components and their elasticity to the market that exactly define the level of leveraged market exposure that is being transferred between two parties. However, as it has been shown previously, the market exposure of a company changes as the project goes through the different development phases; as that happens, so will change the relative weights and the elasticity to the market of the two components in the Hedge Structure according to a precise mathematical model so that the Hedge always mirrors the Strategy. The mathematical model that defines the exact relative weight of each component is based on two ratios that reflect the exact Operating and Financial Leverage that would apply to any given risk phase and that will be known hereafter as Subordination Ratio (SR) and Retention Ratio (RR). The present invention constitutes thus the only alternative (as far as the inventor knows) to the direct sale of the property in order to transfer market risk in the case of property which is being developed and not yet operational. The model can be used in a wide variety of vehicles, such as loans or swaps, to transfer leveraged market risk, as will be shown herein.

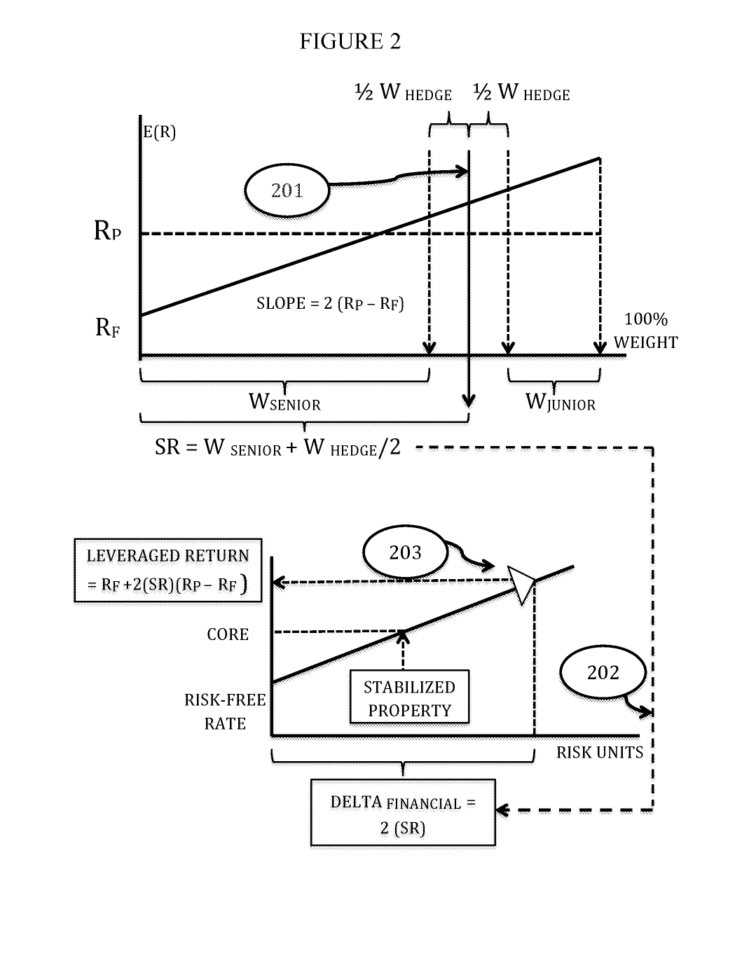

Hedge Structure's Mechanics: Subordination Ratio and Financial Leverage (See FIG. 2).

As was previously explained, the exact relative weight of the yield and growth components and their elasticity to the market are defined by two ratios which are inferred from the specific risk strategy that is to be replicated. The first of the ratios is the Subordination Ratio (SR), which refers to the relative position of the Hedge Structure's principal in the overall capital structure as it relates to its claim to cash flows [201]. The Subordination Ratio (SR) is defined as:

SR=(Weight_{SENIOR POSITION}+Weight_{HEDGE POSITION}/2)

The Subordination Ratio further defines Delta_{FINANCIAL} [202] which provides the Hedge's elasticity to changes in the underlying market due to the use of Financial Leverage [203].

Delta_{FINANCIAL}=2(SR)

It is calculated based on the principle that the overall market return must be allocated to each tier of Opportunity Cost of Capital proportionally to each tier's subordination starting with the first dollar of investment that being not subject to any subordination would have an OCC equal to the risk free rate.

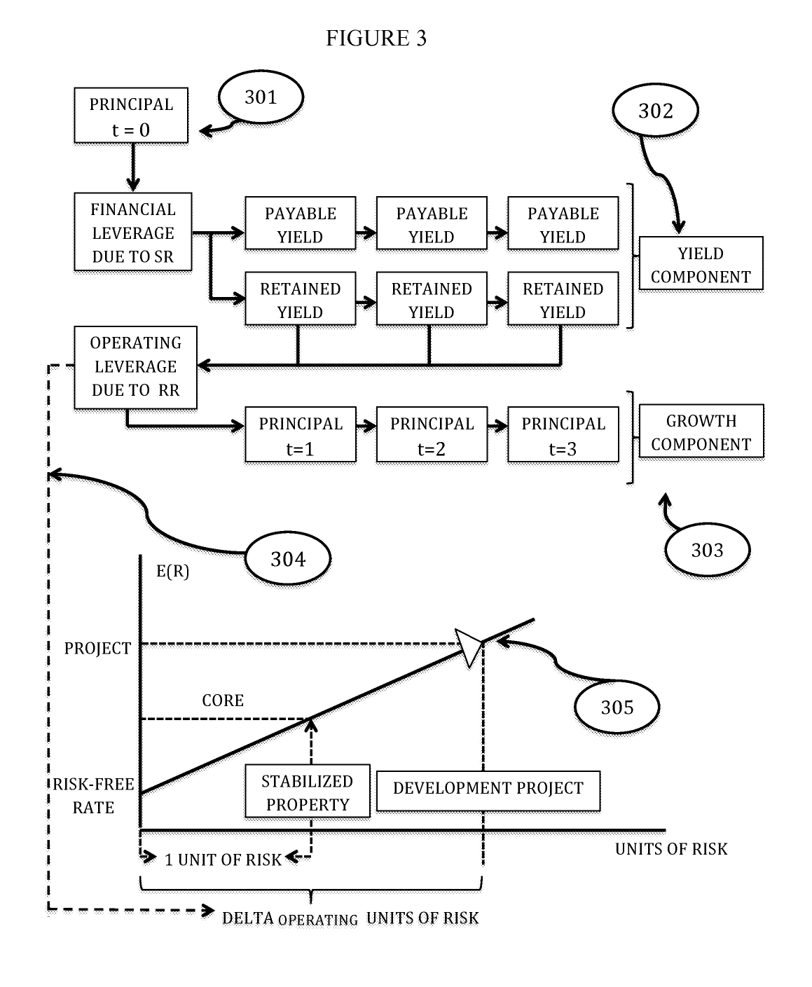

Hedge Structure's Mechanics: Retention Ratio and Operating Leverage (See FIG. 3).

The second ratio that defines the exact relative weight of the yield and growth components and their elasticity to the market is the Retention Ratio (RR) that ranges from 0 to 1. The RR refers to the internal use of funds by the real estate company.

RR=% of yield to be retained for reinvestment

Provided a principal amount for the Hedge Structure [301], the RR defines the percentage in the Yield Component [302] to be retained for reinvestment. It is the Present Value of these future percentages of the Yield to be retained that defines Delta_{OPERATING} [304], which has a leverage effect on the Growth Component [303].

Delta_{OPERATING}=(1+[(1−(1+R_{f})⁻ⁿ)/R_{f}](RR)(Credit Spread)2(SR)

Delta_{OPERATING} provides the Hedge's elasticity to changes in the underlying market due to the use of Operating Leverage [305].

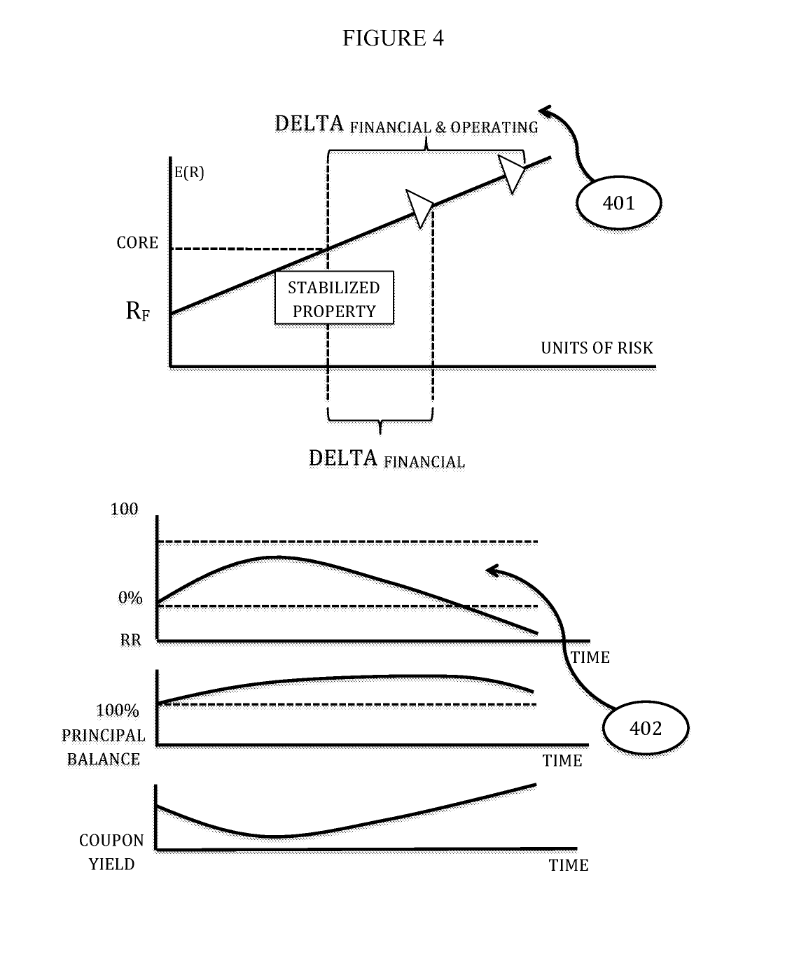

Hedge Structure's Mechanics: Combination of Financial and Operating Deltas (See FIG. 4).

The combination of both Deltas [401] has a multiplicative, rather than additive, effect. Thus, small changes in each Delta can have a much proportionally larger effect on the combined Delta. Another effect occurs as either Delta raises. Higher leverage (either financial or operational) shifts the returns relatively away from current income and toward capital gain. This occurs whether the cash-on-cash leverage is positive or negative. The fundamental reason is that property versus liabilities differential becomes greater in the appreciation return than in the income return as we raise the leverage. Since the operating leverage depends on the Retention Ratio, the higher the RR, the more the return will shift from yield to appreciation. As the RR raises [402] the capital appreciation becomes larger and the current yield becomes smaller all other things equal. The opposite occurs as the RR diminishes. When the RR becomes negative the capital starts to depreciate. The same effect occurs for the Subordination Ratio.

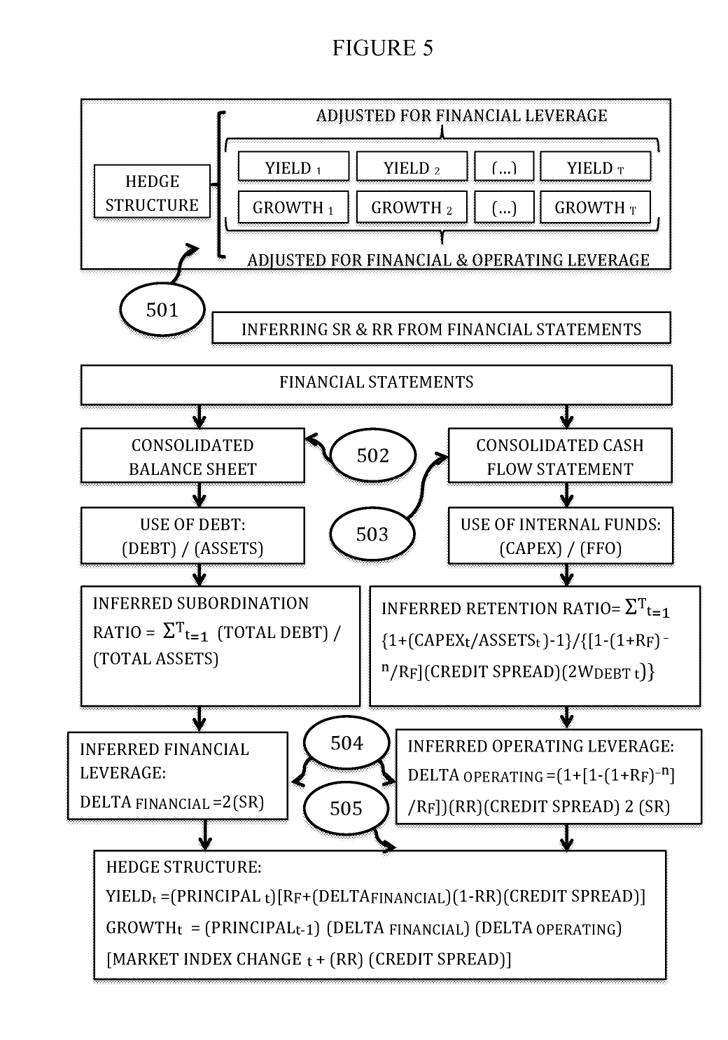

Hedge Structure's Mechanics: Modeling of Hedge Structure (See FIG. 5).

The modeling of the Hedge Structure [501] is based on the two ratios previously defined, namely the Retention Ratio and the Subordination Ratio. As it has been previously mentioned, the Hedge Structure is composed of two components, namely yield and growth. The Subordination Ratio provides Financial Leverage to both of the components but the Retention Ratio, which is based on the percentage of the yield to be reinvested, provides exclusively Operating Leverage to the Growth component. The percentage of Yield retained to be reinvested replicates the Operating Leverage effect that the construction fixed costs have in a development project. Thus the Retained Yield, being uncorrelated to the Growth component's return, provides Operating Leverage.

If RR=0%, no percentage of the yield is reinvested and therefore there is no Operating Leverage applied to the Growth component. The Hedge's Opportunity Cost of Capital with RR=0% is:

OCC_{YIELD} at t=(Principalₜ)[R_{f}+(Delta_{Financial})(Credit Spread)]

OCC_{GROWTH} at t=(Principalₜ₋₁)(Delta_{FINANCIAL})(Change in Market Indexₜ)

The Credit Spread refers to the required spread of the yield over the risk free return based on the credit quality of the company's income and can be inferred from current Cap Rates in the underlying market.
If RR≠0, a percentage of the OCC of the Yield is to be retained by the company for reinvestment. (1-RR) represents the percentage of the OCC to be paid to the investor. The Hedge's Opportunity Cost of Capital with RR≠0% is:

OCC_{YIELD} at t=(Principalₜ)[R_{f}+(Delta_{Financial})(1-RR)(Credit Spread)]

OCC_{GROWTH} at t=(Principalₜ₋₁)(Delta_{FINANCIAL})(Delta_{OPERATING})[Change in Market Indexₜ+(RR)(Credit Spread)]

At the beginning of each period, the Yield's OCC can be regarded as a long position in a Financial Leveraged Market plus a short position in the fixed percentage to be retained by the company at the end of the period. This long-short combination is what provides Operating Leverage to the Growth component.
The initial RR and SR to be used in the hedge structure will be inferred from the company's financial statements from a variable number of previous periods. The exact number of variable periods will vary depending on the length of the development cycle followed by each company. The Financial Statements will be consolidated for all the company's projects. Thus, from the Consolidated Balance Sheet [502], the Initial Subordination Ratio can be inferred in the following way:

SR_{INITIAL}=Σ^{T}ₜ₌₁(Total Debt)/(Total Assets)

From the Consolidated Cash Flow Statement [503], the Initial Retention Ratio can be inferred in the following way:

RR_{INITIAL}=Σ^{T}ₜ₌₁{[1+(CapEx_{Period t}/Average Assets_{Period t})]−1}/{[(1−(1+R_{f})⁻ⁿ)/R_{f}](Credit Spread)(2W_{debt at t})}

With the RR and SR, the Financial and Operating Leverages can be calculated [504]:

Delta_{FINANCIAL}=2(SR)

Delta_{OPERATING}=(1+[(1−(1+R_{f})⁻ⁿ)/R_{f}](RR)(Credit Spread)2(SR)

Finally, the Hedge Structure can be modeled [505]:

Yield Component at t=(Principalₜ)[R_{f}+(Delta_{Financial})(1-RR)(Credit Spread)]

Growth Component at t=(Principalₜ₋₁)(Delta_{FINANCIAL})(Delta_{OPERATING})[Change in Market Indexₜ+(RR)(Credit Spread)]

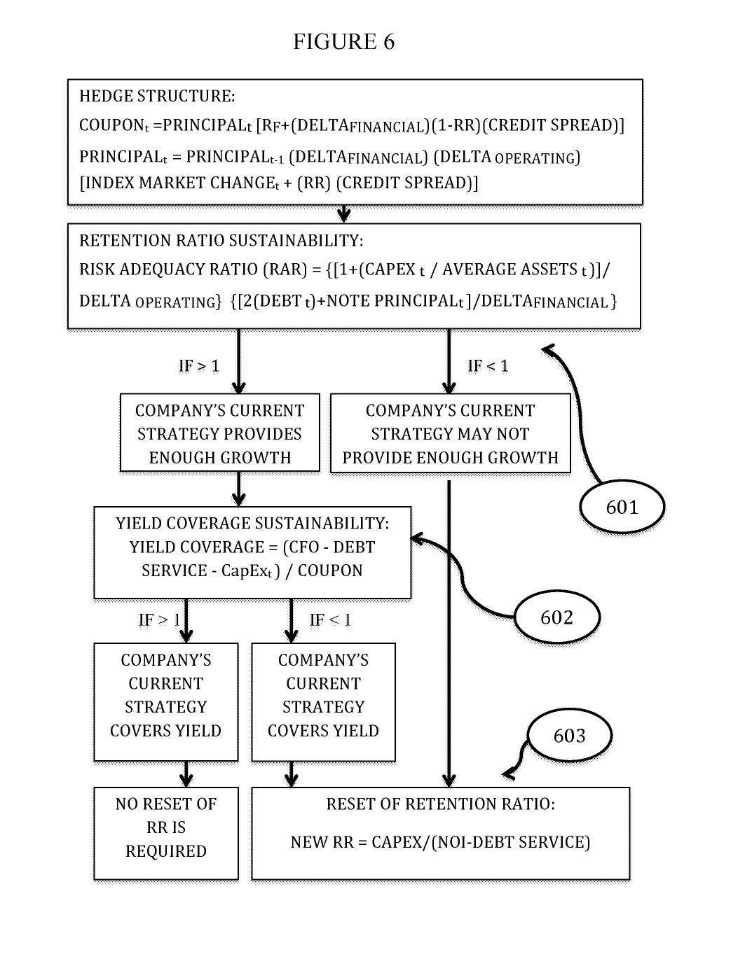

Hedge Structure's Mechanics: Monitoring and Correcting the Hedge Structure (See FIG. 6).

In order for the Hedge Structure to be sustainable, the Retention Ratio must be adjusted in accordance with specific ratios in different company's type of cash flows, namely, cash flows from operations (CFO), cash flows from investing (CFI) and cash flows from financing (CFF) through all and each one of the periods. All ratios are calculated for the whole company using the proportionate consolidation method to define all financial statements. Inputs derived from the consolidated statements provide through every audit are introduced [601] to the following equation:

Risk Adequacy Ratio(RAR)={[1+(CapEx_{Period t}/Average Assets_{Period t})]/Delta_{OPERATING}}{[2(Average Debt_{Period t})+Average Note Principal_{Period t}]/Delta_{FINANCIAL}}

If RAR<1, the company's current strategy is under danger of not providing enough growth to cover the appreciation in the lender's principal. The Retention Ratio should therefore be reduced for the payment structure to be sustainable.
If RAR>1, the company's current strategy provides enough growth for the Retention Ratio to be sustainable. However, as the company uses more resources to grow, there is a risk it may not have enough current resources to cover the yield component of the note according to the established Retention Ratio. The following equation is therefore calculated [602]:

Yield Coverage=(CFO−Debt Service−CapEx_{Period t})/Coupon

If Yield Coverage>1, the current strategy is able to cover the yield component and therefore no readjustment of the Retention Ratio is necessary.
A computer-based logarithm adjusts the Retention Ratio at the end of each quarter to make the payment structure sustainable. The more frequent the rebalance occurs the lower the risk level exposure tracking error is and the higher the costs. The computer-implemented method allows it to set up upper and lower margins under which no rebalancing of the Retention Ratio will be necessary. An optimal corridor width is preset in order to reduce the rebalancing frequency while minimizing the probability of large changes in the Retention Ration. The correction of the RR will be performed in the following way [603]:

RR_{NEW}={[1+(CapEx_{Period t}/Average Assets_{Period t})]−Delta_{OPERATING}}/{(1+[(1−(1+R_{f})⁻ⁿ)/R_{f}](Credit Spread)(2W_{SENIOR}+W_{HEDGE})}+RR_{OLD} if |RAR|>preset margin

Hedge Structure Applications: Simplified Version to be Used for Lending Purposes (See FIG. 7).

The previous structure can be simplified to use Cap Rates measures directly instead of spreads over the risk free rate. Thus, the structure would be:

Couponₜ=(Principalₜ)[(Delta_{FINANCIAL})(1-RR)(Cap Rate)]

Principalₜ=(Principalₜ₋₁)[Delta_{FINANCIAL}+(Delta_{FINANCIAL})²(Cap Rate)(RR)(1−(1+R_{f})⁻ⁿ)/R_{f}][Change in Market Indexₜ+(RR)(Cap Rate)]

As the company's financial statement reflect that the projects go through different development phases, the RR adjusts to reflect the change in the level of risk, changing the relative weights of the Yield (Coupon) and Growth (Change in Principal) components and the Growth elasticity to the market. FIG. 7 shows as an example a portfolio of real estate projects A and B. Project A is developed from the construction phase to the finishes and occupancy phase [702] while project B is developed from a finishes and occupancy phase to a stabilized operation phase [703]. As that happens, the combined portfolio goes from a high Retention Ratio to a low RR [701]. Accordingly the portfolio's return drifts from Principal Appreciation to Yield.

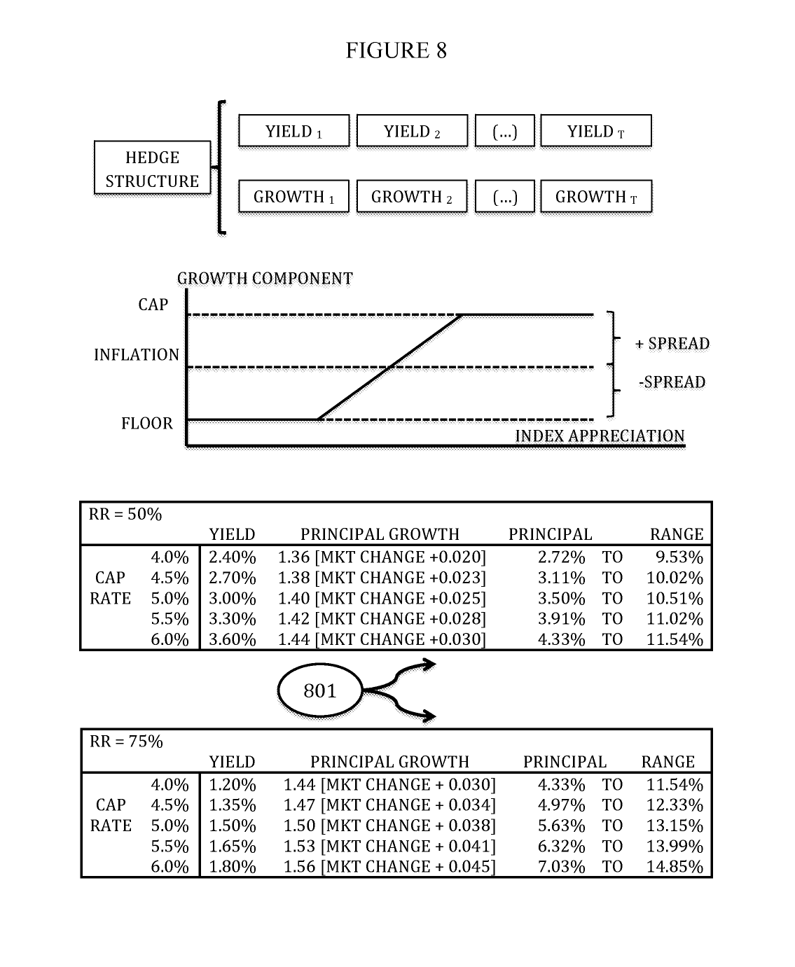

Hedge Structure Applications: Establishing a Cap and a Floor on the Appreciation Component (see FIG. 8).

Different options such as caps and floors can be added to the Hedge Structure to adjust its risk/return characteristics. FIG. 8 shows examples of cap and floor for a Hedge Structure used for lending under two different Retention Ratios [801].

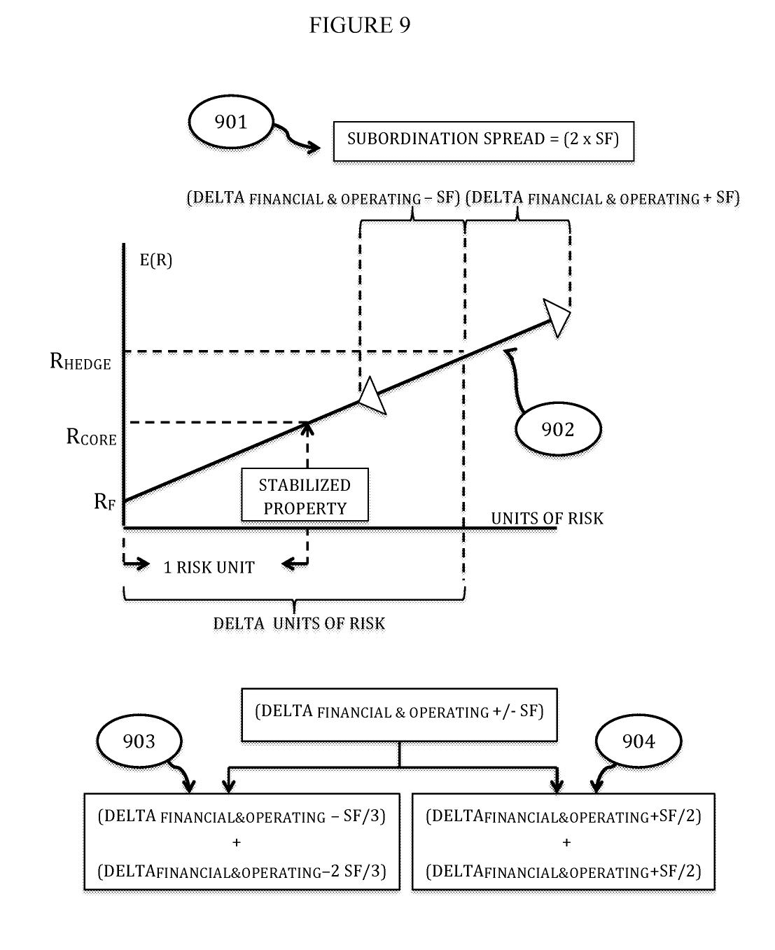

Hedge Structure Applications: Constructing Tranches from Single Hedge Structure (see FIG. 9).

Different tranches with different risk/return characteristics [902] can be constructed from a single Hedge Structure by adding or subtracting a spread [901] on the Combined Financial and Operating Delta. In order for the group of tranches to be sustainable the average of their respective Combined Deltas must equal the original Hedge Structure's Combined Delta [903]. Each tranche can be further divided into smaller tranches as long as the Combined Delta stays constant [904].

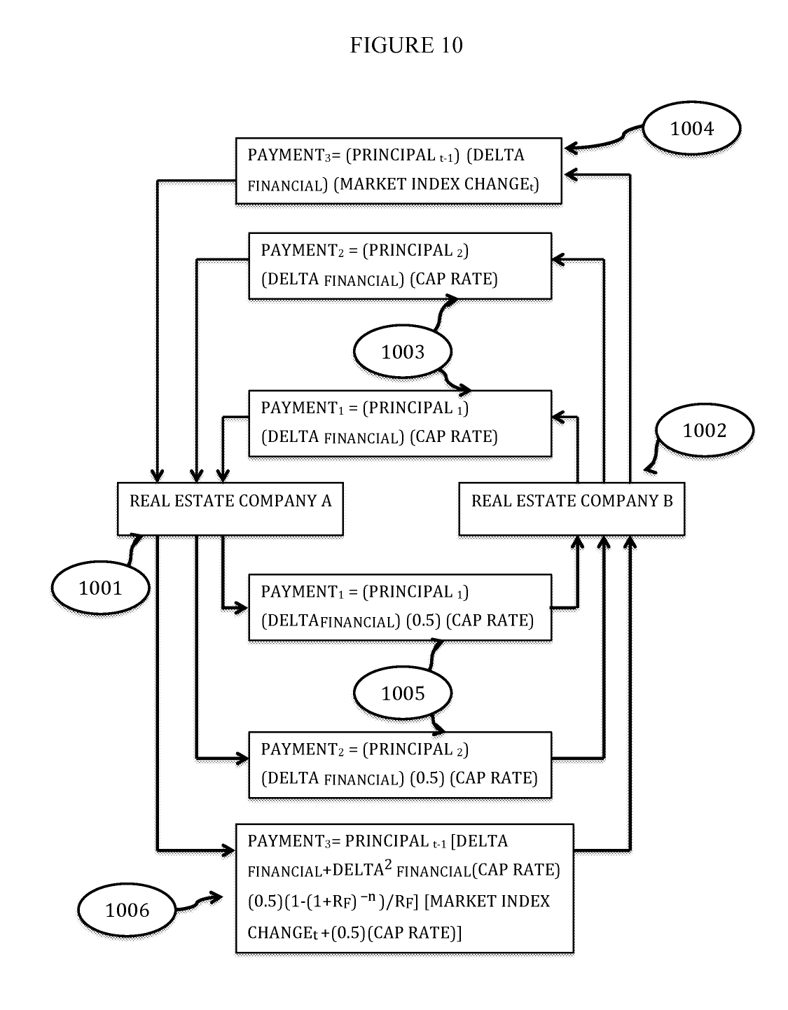

Hedge Structure Applications: Simplified Version to be Used in Swaps for Hedging Purposes (see FIG. 10).

The simplified version previously seen for lending purposes can be further used in swaps for hedging purposes. By using it, two parties could refer their payments to the same market index while adjusting them for the different risk level desired. Provided two parties, Company A [1001] and Company B [1002], of which the former would like to reduce its risk exposure to a specific market and the latter would like to have it increased, a Hedge Structure swap could be set up in the following terms.

The payments to be received by Company A that wants to reduce its risk exposure from an opportunistic level to a stabilized level would be [1003]:

Paymentsₜ=(Principalₜ)[(Delta_{FINANCIAL})(Cap Rate)]

At the end of the swap, Company A would receive a final payment of [1004]:

Final Payment_{T}=(Principal_{T-1})[(Delta_{FINANCIAL})(Change in Market Index_{T})

On the other side, the payments to be made by Company A would be [1005]:

Paymentsₜ=(Principalₜ)[(Delta_{FINANCIAL})(1-RR)(Cap Rate)]

At the end of the swap, Company would make a final payment of [1006]:

Final Payment_{T}=(Principal_{T-1})[Delta_{FINANCIAL}+(Delta_{FINANCIAL})²(Cap Rate)(RR)(1−(1+R_{f})⁻ⁿ)/R_{f}][Change in Market Indexₜ+(RR)(Cap Rate)]

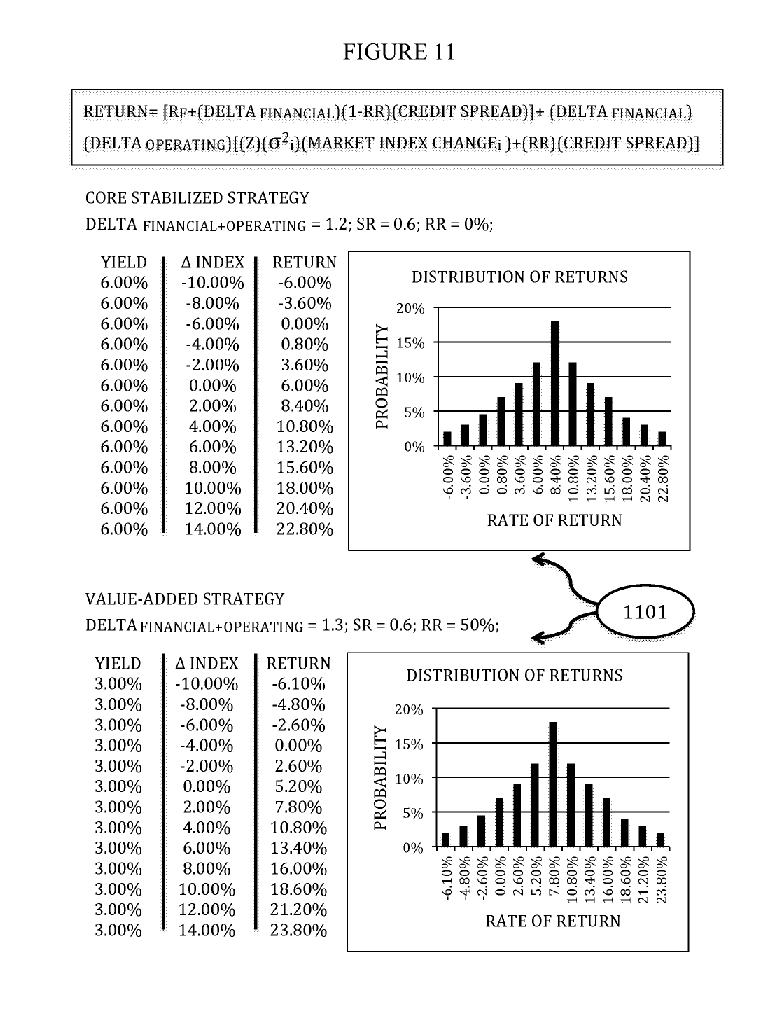

Hedge Structure Analysis: Distribution of Probability of Returns Based on Hedge Structure (see FIG. 11).

A computer-implemented algorithm calculates the probability distribution of returns at any time, based on the established payment structure and the future changes in the index [1101]. The distribution of returns is calculated based on the following formula:

Return=[Rf+(Delta_{FINANCIAL})(1-RR)(Credit Spread)]+(Delta_{FINANCIAL})(Delta_{OPERATING})[(Z)(σ²ᵢ)(Change in Market Indexᵢ)+(RR)(Credit Spread)]

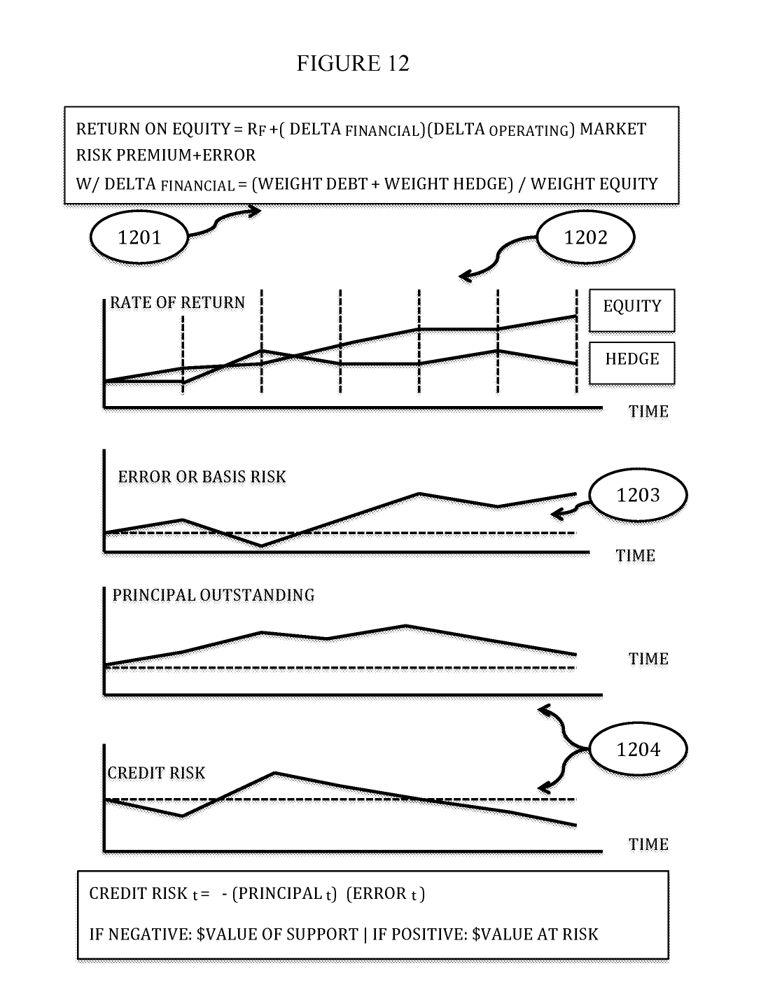

Hedge Structure Analysis: Calculating the Company's Alpha Components (Error Terms) with Regression Analysis (See FIG. 12).

Each company's equity returns can be regressed against the leverage adjusted market return [1202]. Provided a Hedge Structure between a real estate company and an investor the error in the regression constitutes the alpha component in the return [1203] the company is able to obtain from active management by choosing properties that will outperform. From the investor's perspective this error multiplied by the outstanding principal constitutes his potential credit risk in the Hedge Structure. The regression equation is defined as:

R_{Equity}=R_{f}+(Delta_{FINANCIAL})(Delta_{OPERATING})(Market Risk Premium)+error

It must be noted that Delta_{OPERATIONAL} will be the same for both the real estate company and the investor but Delta_{FINANCIAL} will be different since the real estate's capital position has a different subordination to cash flows.

Company's Delta_{FINANCIAL}=(Weight_{DEBT}+Weight_{HEDGE})/Weight_{EQUITY}.

The credit risk [1204] is defined as:

Credit riskₜ=(Principalₜ)(error)

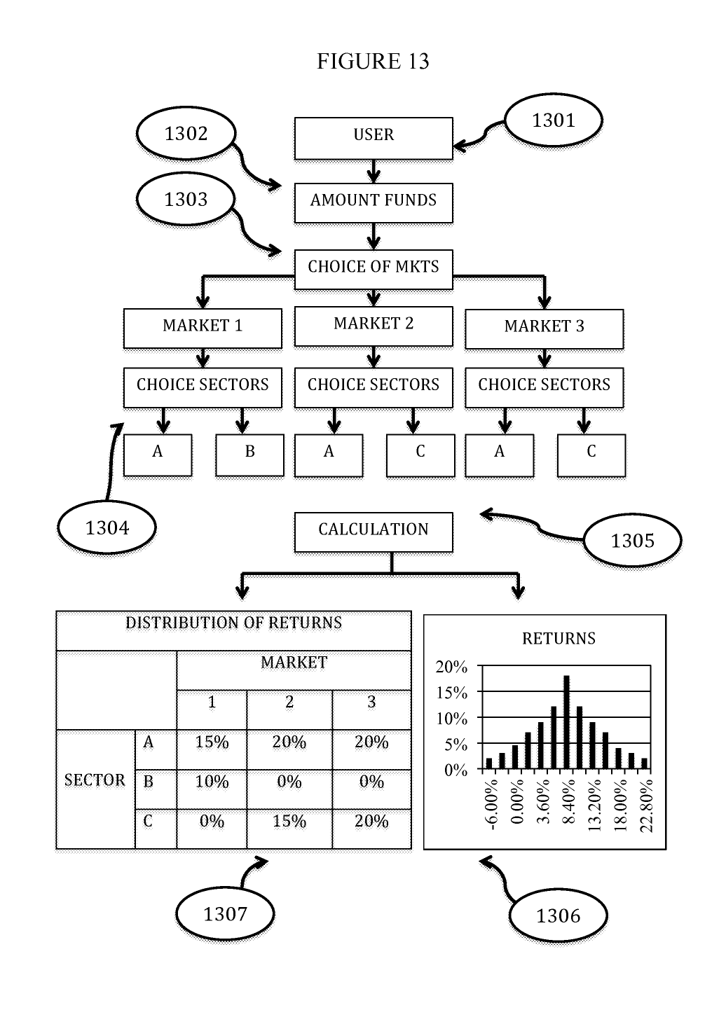

Hedge Structure Analysis: Investment Portfolio Comprised of One or More Hedge Structures (see FIG. 13).

Each investor interacts through interfacing [1301] with a process to select parameters for the subsequent calculations. He first selects the amount of funds he wishes to invest [1302]. He then is shown a matrix [1303] to invest by Market (Northeast, Mid-west, South and West, which correspond to each U.S. region) and Sector [1304] (residential, apartment, industrial, retail, office and hotel) (see FIG. 13). Each combination of market and sector is referenced to a specific underlying index built out of time series data provided by a third party. Each division of the matrix provides a list of companies referenced to the same index but with different elasticity to it depending on the level of financial and operational risk they hold. The investor is able to choose any combination of companies applying different percentages of total investment to each one of them. The software calculates [1305] for each investor the compound distribution of returns [1306] for the specific desired combination [1307] of investments based on the following equation:

Return=(Principalₜ){Σ^{M}ₘ₌₁Σ^{S}ₛ₌₁Σ^{C}_{c=1}[R_{f}+(Delta_{FINANCIAL})(1-RR)(Credit Spread)]+(Delta_{FINANCIAL})(Delta_{OPERATING})[(Z)(σ²ᵢ)(Change in Market Indexᵢ)+(RR)(Credit Spread)]}

Where the first sum refers to each of the markets, the second sum to each of the segments in each market and the third sum to each company in the same market and sector and therefore referenced to the same index i with a volatility=σ²ᵢ. The risk free rate R_{f} will be the same for all companies under all sectors and markets. Both Deltas as well as the Retention Ratio RR and the Credit Spread will vary depending on each company.

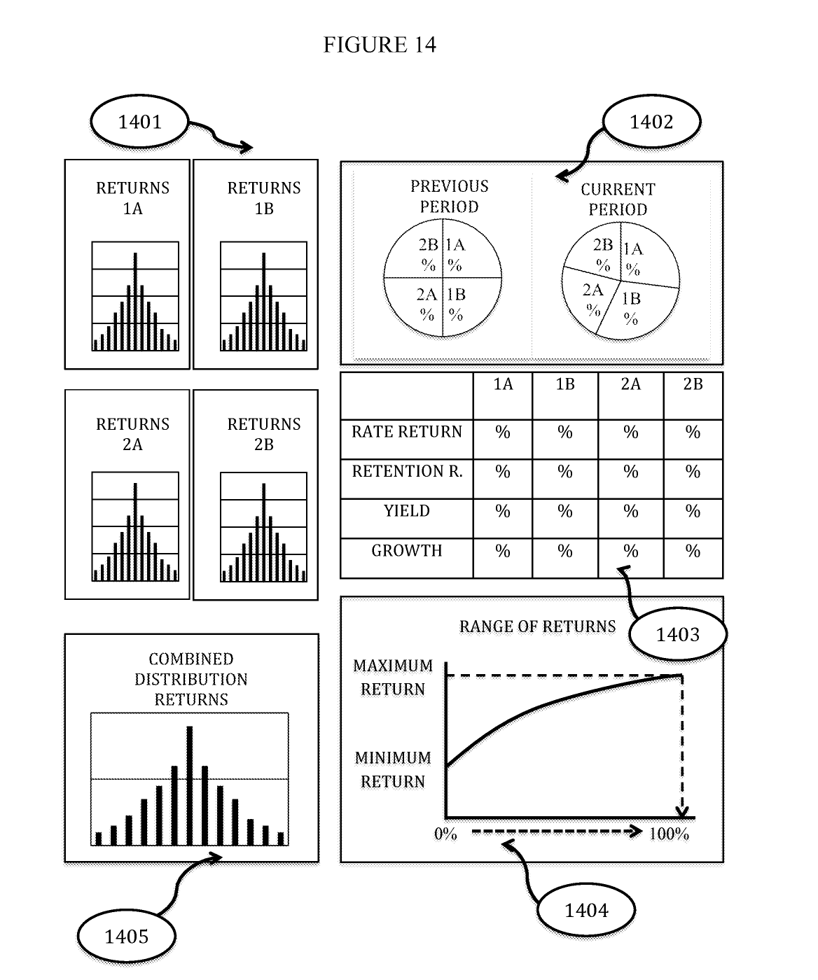

Hedge Structure Analysis: Investment Portfolio Monitoring (See FIG. 14).

As time passes, both Deltas and the RR for each company changes based on their internal use of resources as determined by the audits. Each investor sees this reflected on the compound return for his portfolio [1405] as calculated by the platform's software based on previous formulas. The platform's software can further provide independent distribution of returns per combination of Market and Sector [1401], changes in the portfolio's distribution of funds [1402], distribution of return in the yield and growth components [1403], and range of returns for next period based on Standard Deviation for combined index [1404].

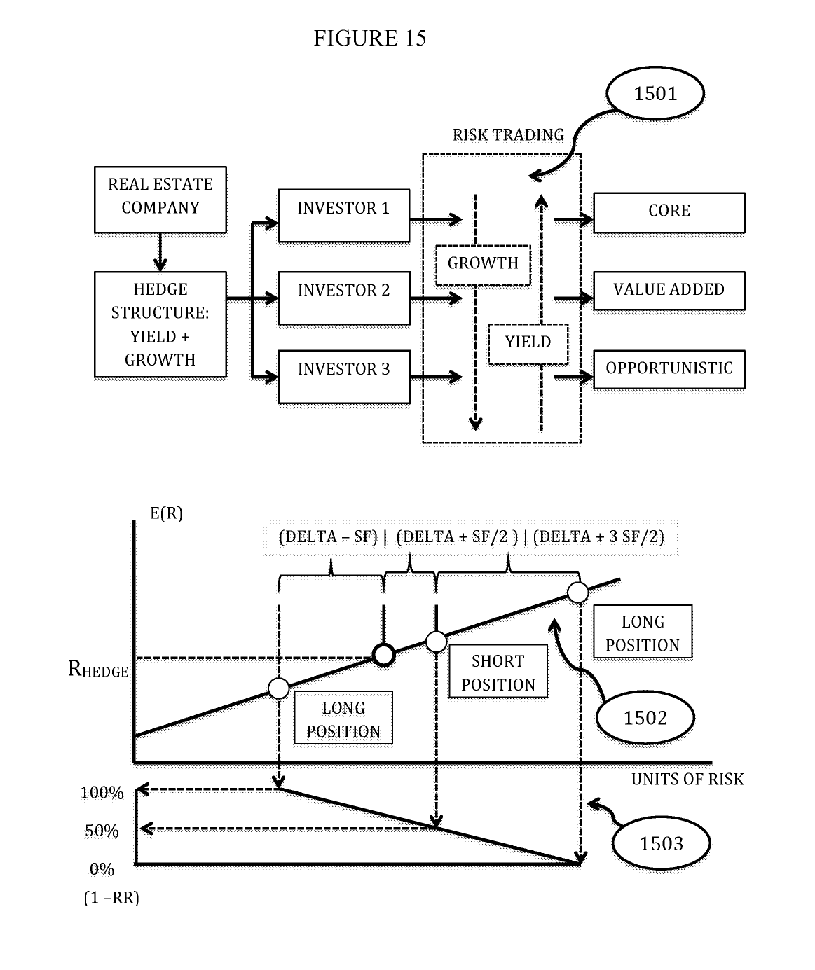

Hedge Structure Analysis: Risk Exposure Rebalancing (See FIG. 15).

As the RR, and therefore the Operating Leverage, in each specific investment varies, the investor has the possibility to enter Hedge Structure Swaps with other platform users in order to change his overall risk level exposure. As the different users enter swaps to exchange yield for growth [1501], their different risk exposures change resembling the desired risk strategy from core to opportunistic. In order for the swaps to be sustainable, different spreads are added or subtracted from the original Hedge Structure's combined Delta [1502] maintaining an equilibrium. Each Delta spread further defines the RR, and thus the exact relation between yield and growth in each swap position [1503].

From the foregoing description of the exemplary embodiments of the invention and operation thereof, other embodiments will suggest themselves to those skilled in the art. Therefore, the scope of the invention is to be limited only by the claims below and equivalents thereof.

What is claimed is:

1. A computer-implemented method for computing, hedging, and transferring adjusted market risk of both financial and operating leverage in real estate between a real estate company and at least one investor in a dynamic way, comprising the following steps:
calculating by a computer the overall specific leverage adjusted market risk the real estate company is exposed to at any time,
structuring by a computer selected components of a Hedge Structure so as to effectively transfers risks from the real estate company to the investor, and
matching, through the use of computer-based calculations, the return/risk characteristics of the internal components of the Hedge Structure to those of the real estate company's assets.

2. The computer-implemented method of claim 1, further comprising the step of making necessary internal adjustments throughout the investment cycle.

3. The computer-implemented method of claim 2, wherein the investment is comprised of a portfolio of investments in different companies, each one of them transferring a different market risk.

4. The computer-implemented method of claim 1, where the investment is comprised of a portfolio of investments in different companies, wherein each one of them transfers a different market risk.
